(19) United States
(12) Patent Application Publication
(10) Pub. No.: US 2019/0287721 A1
(43) Pub. Date: Sep. 19, 2019

(54) VERY HIGH CAPACITANCE FIM CAPACITOR AND METHOD FOR THE PRODUCTION OF SAME

(71) Applicant: BLUE SOLUTIONS, Ergue Gaberic (FR)

(72) Inventor: Jean-Michel DEPOND, Quimper (FR)

(21) Appl. No.: 16/338,978

(22) PCT Filed: Sep. 28, 2017
(86) PCT No.: PCT/EP2017/074619

§ 371 Date: Apr. 2, 2019

(30) Foreign Application Priority Data
Oct. 3, 2016 (FR) 1659489

(51) Int. Cl. H01G 4/18; H01G 4/33; H01G 4/32; H01G 4/015

(52) U.S. Cl. CPC H01G 4/18; H01G 4/015; H01G 4/32; H01G 4/33

(57) ABSTRACT

The present invention relates in particular to a very high capacitance film capacitor (1) that comprises a dielectric layer (100) consisting of at least one dielectric film (100a, . . . , 100i), each dielectric film (100a, . . . , 100i) of this dielectric layer (100) having the following parameters: —a relative dielectric permittivity [ε_{f}ⁱ] such that ε_{f}ⁱ≥10, —a thickness [e_{f}ⁱ] such that 0.05 μm≤e_{f}ⁱ≤50 μm, —a dielectric strength [E_{f}ⁱ] such that E_{f}ⁱ≥50 V/μm, parameters in which “f” signifies “film” and i≥1, “i” designating the “i^{th}” dielectric film (100i) of said dielectric layer (100), this dielectric layer (100) separating a first electronic charge carrier structure (200) from a second electronic charge carrier structure (300), these two structures having an opposite surface (S) separated by the dielectric layer (100).

### FIELD OF THE INVENTION

The present invention relates to a very high capacitance film capacitor, as well as a method for manufacturing such a capacitor.

### TECHNOLOGICAL BACKGROUND OF THE INVENTION

A film capacitor consists of two structures which are generally metallic, charge-bearing and separated by a dielectric insulator. This insulator is in the form of at least one film, generally a self-supporting polymer film, which is characterized by an average thickness [e_{f}] with 0.05 μm<e_{f}<50 μm typically, and a relative dielectric permittivity [ε_{f}] where ε_{f}>1.

Since the capacitance of a film capacitor is proportional to ε_{f} and inversely proportional to e_{f}, a very high capacitance film capacitor (hereinafter abbreviated “VHCFC”) can be obtained by using a dielectric insulator of small thickness (e_{f}<<10 μm, the sign “<<” meaning “lower or even much lower than”) and high relative dielectric permittivity (ε_{f}>>10, the sign “>>” meaning “higher or even much greater than”).

The roughness of this film and/or the configuration of the stack described above mean(s) that, in most cases, areas filled with air may be present. Their thickness however remains small compared to e_{f} (≤1 μm and ≤10% e_{f} typically).

This phenomenon is known and utilized in the case of impregnated capacitors where the air is then replaced by an impregnant, generally a dielectric liquid of relative dielectric permittivity [εᵢ] close to ε_{f} (|ε_{f}−εᵢ|≤2 typically). In the case of non-impregnated capacitors (called “dry capacitors”), the air of relative dielectric permittivity [εₐᵢᵣ] substantially equal to 1, is then locally in series with the main dielectric insulator. Because of the effective thickness of the areas containing the air, this presence in the stack has little influence on the operation of the capacitor when ε_{f}<<10. But this is no longer the case in a VHCFC where ε_{f}>>10.

More generally, when the operating gradient becomes high (≥50 V/μm), the presence of these areas where the dielectric characteristics are different and generally lower compared to those of the main insulator, may cause partial discharges or unwanted breakdowns, damaging to the capacitor or, at a minimum, to its performance (isolation resistance and leakage current typically). And this is all the more true that ε_{f} is high.

In addition, the most common electrical energy storage devices are capacitors, supercapacitors and batteries.

The capacitors are of several types (film, ceramic, electrochemical types, etc.) but store all the energy by capacitive effect: the stored charge [Q] is proportional to the capacitance [C] of the storage device and to the voltage [U] at the terminals of this device, so that Q=C×U.

Even if the voltage can be very high (U>>1000 V), the capacitance is very low (C<<1 F) and the amount of charges stored is therefore also low (Q<<10⁻³ Ah). However, the response time [τ] is very fast (τ<<10⁻³ s), which allows the capacitor to respond to power peaks.

The capacitor is therefore rarely used as an energy storage device, or only when the amount of energy involved is very low and/or the requested power is high (such as for example the flash of a lamp).

Supercapacitors are electrochemical devices that store energy mainly by capacitive effect.

Due to their electrochemical nature, the voltage is low (U<<10V). However, due to their structure, the capacitance is very high (C>>1 F) and the response time is fast (τ≈1 s).

The supercapacitor is therefore used to store an amount of energy or of average charges (Q≈1 Ah) to be used over a short time (a few tens of seconds) or under high powers (such as the starting of an engine for example).

The batteries are electrochemical devices that store the energy mainly by electrochemical reaction: the stored charge is proportional to the amount of reacting material.

Due to their electrochemical nature, the voltage is low (U<<10 V) and the response time is slow (τ>>1 s), but the amount of charges stored can be very high (Q>>10 Ah).

The battery is therefore used to store a large amount of energy (a few thousand Ah) to be used over a medium to long time (a few hours) and with moderate power calls (such as the operation of an engine for example).

Since capacitors and supercapacitors involve only charge movements, they have short response times, a symmetrical charge and discharge behavior, and a high ability to repeat cycles (more than several million cycles typically).

This is not the case for batteries where the charges move but especially participate in an electrochemical reaction. The latter limits the response time, causes asymmetry in the charging and discharging behavior, and greatly reduces the ability to repeat cycles (less than a few thousand cycles typically).

Very high capacitance film capacitors, based on dielectric films with very high relative dielectric permittivity [ε_{f}] (ε_{f}≥10), provide a technological breakthrough. They present the advantages of each of the above-mentioned electrical energy storage technologies (high voltage, fast response time, high amount of charges, strong ability to repeat cycles), without their disadvantages.

They constitute in themselves a new class of devices that can replace each of the conventional electrical energy storage devices. Especially, it is possible to adapt the values of ε_{f} and ε_{f} to the field of application. For example, in the case of a typical battery application, a very high surface capacitance will be sought, using a small thickness (ε_{f}≤2 μm) and a very high relative dielectric permittivity (ε_{f}≥2000). In this case, the device will have a reasonable surface, in agreement with the powers requested by the application (there is, for a given technology, a power/surface limit beyond which the technology is no longer viable, largely for thermal reasons).

In the case of a typical supercapacitor application, where the requested powers are significantly higher while the energy requested is lower, it will be necessary to work with larger surfaces. This requires therefore the use of a dielectric film of greater thickness (1 μm≤e_{f}≤5 μm) or of lower relative dielectric permittivity (100≤ε_{f}≤2000).

In the case of a typical capacitor application, where energy is not a criterion but where the operating voltage is often high, it will be possible to work with a dielectric film of high thickness (e_{f}≥5 μm) and low relative dielectric permittivity (10≤ε_{f}≤100) while gaining more surface compared to conventionally used dielectric materials.

### SUMMARY OF THE INVENTION

The design of the film capacitors as described above is not suitable for very high capacitance film capacitors [VHCFC] using dielectric films which have very high relative dielectric permittivity [ε_{f}] (ε_{f}≥10), whether in a dry or impregnated configuration.

In both cases, the unavoidable existence of areas having dielectric characteristics much lower than those of the main dielectric film prevents the correct operation of the capacitor, especially:
by decreasing the real capacitance via a decrease in the local relative dielectric permittivity;
by increasing the leakage current through the presence of local partial discharges;
degrading the breakdown voltage via a decrease in the local dielectric strength.

The present invention aims to provide a solution to these problems.

A first object of the present invention therefore relates to a very high capacitance film capacitor using at least one dielectric insulator of relative permittivity ε_{f}≥10 and in which the possible presence of areas where the relative dielectric permittivity is locally much lower than ε_{f} does not lead to degradation of the performance of the capacitor.

Thus, a first aspect of the invention relates to a very high capacitance film capacitor which includes a dielectric layer consisting of at least one dielectric film, each dielectric film of this dielectric layer having the following parameters:
a relative dielectric permittivity [ε_{f}ⁱ] such that ε_{f}ⁱ≥10,
a thickness [e_{f}ⁱ] such that 0.05 μm≤e_{f}ⁱ≤50 μm,
a dielectric strength [E_{f}ⁱ] such that E_{f}ⁱ≥50 V/μm,

parameters in which “f” means “film” and i≥1, “i” designating the “i^{th}” dielectric film of said dielectric layer,

this dielectric layer separating a first electronic charge-bearing structure from a second electronic charge-bearing structure, these two structures having an opposite surface S separated by the dielectric layer,

characterized by the fact that:

A/ the interface between the dielectric layer and the first structure meets the following requirements:
the portion of the opposite surface where said first structure is directly in contact with said dielectric layer is greater than 90%,
in all the areas of the interface where the dielectric layer is not directly in contact with said first structure, they are separated locally by N (with N≥1) thicknesses of “parasitic” dielectrics, each thickness having a relative dielectric permittivity [εₚ^{j}] and a dielectric strength [Eₚ^{j}] which satisfy the relation:

εₚ^{j}Eₚ^{j}≥Min(ε_{f}ⁱE_{f}ⁱ)

where “p” means “thickness of parasitic dielectrics” and “j” refers to the “j^{th}” thickness, with 1≤j≤N,

B/ the interface between the dielectric layer and the second structure meets the following requirements:
the portion of the opposite surface where said second structure is directly in contact with said dielectric layer is greater than 90%,
in all the areas of the interface where the dielectric layer is not directly in contact with said second structure, they are locally separated by M (with M≥1) thicknesses of “parasitic” dielectrics, each thickness having a relative dielectric permittivity [εₚ^{k}] and a dielectric strength [Eₚ^{k}] which satisfy the relation:

εₚ^{k}Eₚ^{k}≥Min(ε_{f}^{k}E_{f}^{k})

where “p” means “thickness of parasitic dielectrics” and “k” refers to the “k^{th}” thickness, with 1≤k≤M,

with the following additional condition:

C/ when said dielectric layer consists of more than one dielectric film, then any interface Σ between two dielectric films satisfies the following conditions:
the portion of the opposite surface where the two dielectric films are directly in contact is greater than 90%,
in all the areas of the interface Σ where the two dielectric films are not directly in contact, these films are locally separated by P_{Σ} (with P_{Σ}≥1) thicknesses of “parasitic” dielectrics, each thickness having a relative dielectric permittivity [εₚ^{l}] and a dielectric strength [Eₚ^{l}] which satisfy the relation:

εₚ^{l}Eₚ^{l}≥Min(ε_{f}ⁱE_{f}ⁱ)

where “p” means “thickness of parasitic dielectrics” and “l” refers to the “l^{th}” thickness, with 1≤l≤P_{Σ}, said dielectric layer being made of polymer material or based on polymer material, excluding an exclusively mineral material.

According to a preferred embodiment of this capacitor, said dielectric layer is not self-supporting.

Another aspect of the invention relates to a method for manufacturing a film capacitor according to the above characteristic, characterized by the fact that it has the following successive steps:

a) using a second dielectric layer called “support layer”, of relative dielectric permittivity [ε_{f}′] and of thickness [e_{f}′], which is metallized on at least one of its both opposite sides, and of dielectric strength [E_{f}′],

b) depositing said dielectric layer on said support layer so that it is in contact with a metallized side of this support layer,

c) proceeding to the metallization of the side of said dielectric layer which remains free at the end of step b),

d) proceeding to the coiling on itself of the set resulting from step c) or to the stacking of several sets resulting from step c),

said dielectric layer and support layer satisfying the following relation:

e_{f}′ E_{f}′≥e_{f} E_{f}, wherein the expressions e_{f} and E_{f} are defined in claim 1.

According to other advantageous and non-limiting characteristics of this method:
a support film which is metallized on its both sides is used, and in step d), the metallized surface of said dielectric layer is matched, that is to say mirrored, with that of one of the sides of said support layer;
a metallized support film is used on one of its sides and in step d), the metallized surface of said dielectric layer is matched, that is to say mirrored, with that of said support layer;
a support layer, whose relative electric permittivity [ε_{f}′] is less than or equal to 10, is used;
the implementation of step d) is carried out by operating under vacuum or at a pressure less than or equal to 10 mbar;
in step d), a plating of a new set on the previous one is carried out by applying a pressure, especially via a pressure roller, or by controlling the tension angle;
the method has the following steps:

a) depositing said dielectric layer on a support film consisting of a metal strip;

b) depositing the set resulting from step a) on a dielectric support layer;

c) depositing the set resulting from step b) on a second support film consisting of a metal strip;

d) proceeding to the coiling on itself of the set resulting from step c) or to the stacking of several sets resulting from step c);
said dielectric layers are identical;
said support films are identical metal strips;
between said steps a) and b), the side of said dielectric layer that has remained free is subjected to a metallization;
between said steps b) and c), the side of said dielectric support layer that has remained free is subjected to a metallization;
the implementation of step d) is carried out by operating under vacuum or at a pressure less than or equal to 10 mbar;
in step d), a plating of a new set on the previous one is carried by applying a pressure, especially via a pressure roller, or by controlling the tension angle;
porous strips are used;
strips which incorporate fuses are used;
the incorporation of said fuses is carried out by using either of the following techniques:

a) removal of material from said strip, such that the remaining material constitutes said fuses, which removal is carried out by a technique such as spraying of the metal, punching or mechanical drilling of the metal, dissolution or chemical etching of the metal;

b) addition of material to said strip, so that the added material constitutes said fuses, which addition is carried out by a technique such as welding, brazing, clinching or stamping.

### BRIEF DESCRIPTION OF THE DRAWINGS

Other characteristics and advantages of the invention will appear upon reading the following description of a preferred embodiment of the invention. This description is made with reference to the appended drawings in which:

FIG. 1 is a very schematic three-dimensional view of a very high capacitance film capacitor (VHCFC) comprising a single dielectric film as a dielectric layer, which capacitor is represented according to a configuration called “ideal” configuration;

FIG. 2 is a view of the capacitor of FIG. 1 along the sectional plane P;

FIG. 3 is a view similar to FIG. 1 in which the capacitor is represented in a real configuration where “parasitic” dielectrics are present;

FIG. 4 is a view of the capacitor of FIG. 3 along the sectional plane P;

FIGS. 4a and 4b are enlarged views of the regions of FIG. 4 identified by circles;

FIG. 5 is a view similar to FIG. 1, always in an ideal configuration, the dielectric layer consisting of several dielectric films;

FIG. 6 is a view of the capacitor of FIG. 5 along the sectional plane P;

FIG. 7 is a view similar to FIG. 5 in which the capacitor is represented according to a real configuration where “parasitic” dielectrics are present;

FIG. 8 is a view of the capacitor of FIG. 7, along the sectional plane P;

FIGS. 8a, 8b and 8c are enlarged views of the regions of FIG. 8 identified by circles;

FIG. 9 is a vertical sectional view of a stack obtained at the end of the first step of manufacturing a film capacitor such as the one represented in the preceding figures (with a dielectric film that is not self-supporting);

FIG. 10 is a vertical sectional view of a stack obtained at the end of the second step which follows the one illustrated in FIG. 9;

FIG. 11 is a vertical sectional view of a stack obtained at the end of a variant of the second step illustrated in FIG. 10;

FIG. 12 is a vertical sectional view of a stack obtained at the end of the first step of another embodiment of manufacturing a film capacitor such as the one represented in FIGS. 1 to 8c;

FIG. 13 is a view similar to FIG. 12, showing a variant;

FIG. 14 is a vertical sectional view of a stack obtained at the end of the second step which follows the one illustrated in FIG. 12;

FIG. 15 is a vertical sectional view of a stack obtained at the end of the second step which follows the one illustrated in FIG. 13;

FIGS. 16 and 17 are respectively vertical sectional views of variants of the stacks of FIGS. 14 and 15;

FIG. 18 is a vertical sectional view of a self-supporting film that has been metallized on its both sides, obtained at the end of a first step of manufacturing a capacitor;

FIG. 19 is a vertical sectional view of a stack obtained at the end of a step that follows the one illustrated in FIG. 18;

FIG. 20 is a view similar to FIG. 19 but showing a variant of the method resulting from this step;

FIG. 21 is also a view similar to FIG. 19 showing yet another variant;

FIG. 22 is a vertical sectional view of a stack obtained according to another embodiment;

FIG. 23 is a vertical sectional view of the method obtained at the end of a first step of a variant of the embodiment of FIG. 22;

Finally, FIG. 24 is a vertical view of the stack obtained following a second step which follows the step of FIG. 23.

### DEFINITIONS

In the present application and unless otherwise mentioned, the following definitions will be valid.

It is meant by “all-film capacitor” a film capacitor in which the electronic charge-bearing structures (hereinafter abbreviated “ECBS”) are independent metal sheets of the dielectric layer. The metal sheets are typically made of aluminum or copper, or any other metal or metal alloy that can be formed into a sheet of a thickness less than or equal to 100 μm typically.

It is meant by “metallized film capacitor” a film capacitor in which the ECBS are metal layers deposited on at least one side of the dielectric layer. The metal deposition consists especially of aluminum, zinc, copper, silver, gold, platinum, chromium, alloy of two or more of these metals, successively deposited layers of these metals or metal alloys typically, or any other metal, metal alloy or succession of metal layers can be deposited according to a conventional metallization technique, such as vacuum evaporation, physicochemical vacuum deposition or the same.

One of the major advantages of the “metallized film” technology is the possibility of self-regeneration of the capacitor in the presence of a defect. Thus, when a defect becomes critical, the capacitor goes into “breakdown”, that is to say an internal short-circuit is created via the defect between the two ECBSs. The capacitor is then no longer functional. The very localized power released by the short-circuit (which generally takes the form of a micro electric arc) induces a demetallization by thermal spraying of the two ECBSs around the defect. The distance of establishment of the short-circuit therefore increases as demetallization progresses. At a certain moment (which depends on a large number of parameters including the nature and the thickness of the metallized layer, the nature and the thickness of the dielectric layer, the “AC” (alternating current) or “DC” (direct current) nature and the value of the operating voltage, the coiling pressure, etc.), the distance of establishment becomes too great for the short-circuit to be maintained.

The breakdown stops and the capacitor becomes functional again: it is “regenerated”. This phenomenon is practically impossible in an all-film capacitor because the thickness of the ECBSs is too great compared to the available local power for there to be a sufficient demetallization around the defect. Moreover, this phenomenon has nothing systematic in a metallized film capacitor: the power released by the short-circuit does not only demetallize the ECBSs around the defect, it also heats the capacitor volume around the defect. This rise in temperature can trigger a thermal avalanche phenomenon by collapsing of the dielectric (including mainly dielectric strength) and thermomechanical (it is possible to go up to the fusion) properties of the materials comprised in the impacted volume. The defect is then “diffused” gradually through the capacitor whose total energy becomes insufficient to regenerate the defect.

The term “extrusion” refers to any thermomechanical method that makes it possible to transform a plastic material in the mechanical sense into a self-supporting film or not, via a technique of compression, passage through a die, and optionally stretching and/or crosslinking and/or deposition on a substrate.

The term “coating” refers to any method for depositing a fluid film on a substrate, generally followed by drying and optionally crosslinking, in order to obtain a self-supporting film or not.

It is meant by “coiled capacitor” any film capacitor obtained by coiling of an “ECBS 1/Dielectric layer 1/ECBS 2/Dielectric layer 2” structure on itself. It should be noted that the dielectric layers 1 and 2 may actually consist of several separate dielectric films coiled in parallel. “ECBS 1” and “ECBS 2” then constitute the two electrically insulated poles of the capacitor.

It is meant by “stacked capacitor” any film capacitor obtained by a stack of an “ECBS 1/Dielectric layer 1/ECBS 2/Dielectric layer 2” structure on itself. It should be noted that the dielectric layers 1 and 2 may actually consist of several separate dielectric films stacked on top of each other. “ECBS 1” and “ECBS 2” then constitute the two electrically insulated poles of the capacitor.

These two last designations are extended to the concept of “multitrack capacitor” (coiled or stacked) for which one or more intermediate ECBSs, insulated from each other as well as from ECBS 1 and ECBS 2, and coplanar with ECBS 1 or ECBS 2, are introduced into the structure so that each intermediate ECBS belongs to two capacitors and provides gradually the series connection of all the capacitors formed accordingly between the main poles ECBS 1 and ECBS 2.

The advantage of a multitrack structure is to optimize the series connection of capacitors within the same coiled or stacked structure and therefore, without having to add additional conditioning or connectivity means.

It will be noted that in the case where there is an odd number of intermediate ECBS, ECBS 1 and ECBS 2 become coplanar insofar as they refer to the two poles of the multitrack capacitor.

Finally, in a coiled capacitor, there are several means for controlling the coiling pressure in order to ensure good plating of the films coiled on each other.

The first one is to use a pressure roller that presses with a constant pressure on the coil at the location of the coiling. This pressure is equal to the coiling pressure and is constant over the entire winding.

The second one is to control the coiling pressure of each coiled film by the coiling tension (via the tensile force exerted on the film) and the coiling angle (also called “tension angle”). The coiling pressure is then related to the mechanical characteristics of each coiled film, as well as to the coiling radius, and therefore varies not only from one coiled film to the other, but also through the winding.

Throughout the present application, including claims, the dielectric layer is made of a polymer material or based on polymer material (i.e., consisting of a polymer matrix containing inclusions of an organic and/or mineral nature). In any case, the use of exclusively mineral materials is excluded.

Examples of materials constituting this dielectric layer are given in documents US-A-2016/0254092 and WO A 2016/073522.

Advantageously, the “parasitic” dielectrics are of gaseous (such as air, a neutral gas, etc.), liquid (such as mineral or organic oil, water, etc.) or solid (such as a polymer, mineral dusts, organic material such as grease, etc.) nature.

### DETAILED DESCRIPTION OF THE INVENTION

A first object of the present invention is a very high capacitance film capacitor [VHCFC].

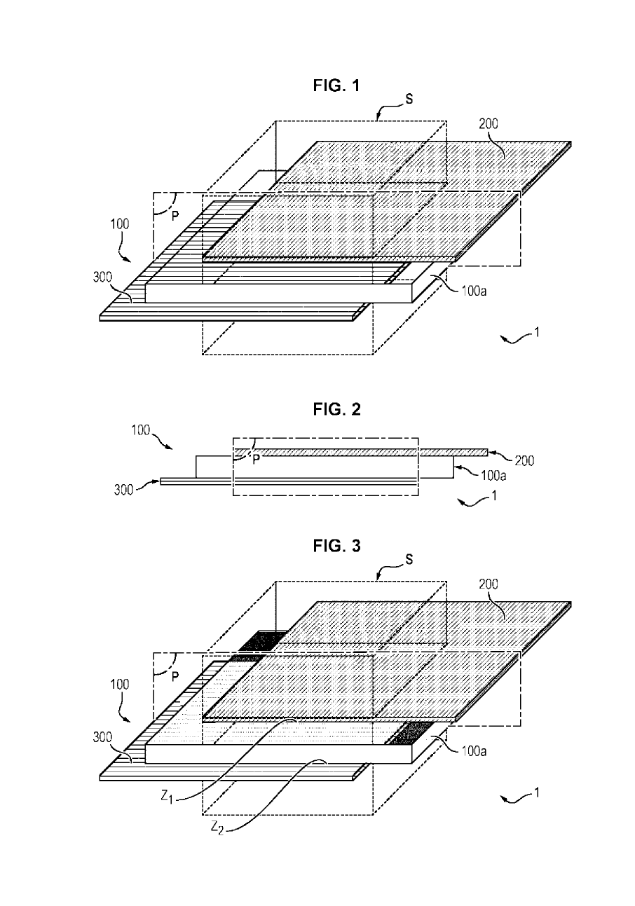

An example of such a VHCFC 1 is represented in the appended FIG. 1.

This capacitor 1 is formed of at least one dielectric film 100, also called “layer” (in this case, a single film 100a is represented here), which separates a first charge-bearing structure 200 (abbreviated ECBS), from a second charge-bearing structure 300.

In the figures, the ECBSs 200 and 300 have been represented in such a way that they are not completely facing each other. This constitutes an exaggerated representation of what is happening in reality. Indeed, even if there is generally an offset to avoid metallization edge electric arcs, this offset is much smaller than the one represented.

Ideally, the interface areas between the dielectric film 100a and the two ECBSs are devoid of any imperfection, so that their adhesion is perfect.

But this is only a theoretical case.

In practice and as illustrated in FIG. 3, the opposite sides of the film 100a and of the two ECBSs are irregular, so that they are separated locally by at least one thickness of parasitic dielectrics.

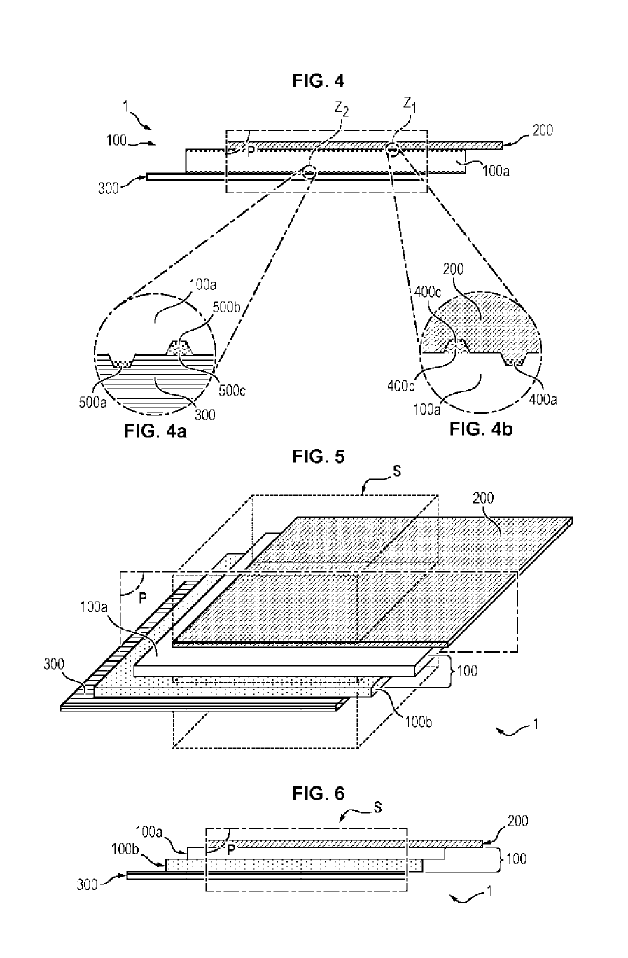

Referring now to FIG. 4, two areas Z1 and Z2 where at least one thickness of parasitic dielectrics is involved, are represented by way of example.

Thus, the area Z1 is located at the interface between the film 100a and the upper ECBS 200.

It shows a first thickness of parasitic dielectrics 400a interposed between a protrusion on the surface of the ECBS 200 and a recess on the surface of the film 100a.

It also distinguishes, but at another location, two successive thicknesses 400b and 400c at the interface.

As for the area Z2, it is located at the interface between the film 100a and the lower ECBS 300.

It shows a first thickness of parasitic dielectrics 500a interposed between a protrusion on the surface of the film 100a and a recess on the surface of the ECBS 300.

It also distinguishes, but at another location, two successive thicknesses 500b and 500c at the interface.

These are of course very simplified artist views given by way of illustration. Neither the geometry (width, thickness, shape, etc.), nor the position at the interface, nor the constitution (one or two thickness/thicknesses of parasitic dielectrics) are representative of reality.

These thicknesses may consist of air and/or foreign bodies that may have adverse impact on the parameters of the VHCFC constituted accordingly.

However, the present applicant has pointed out that it is possible to obtain a quality VHCFC as far as the dielectric film 100a has the following parameters:
a relative dielectric permittivity [ε] such that ε≥10,
a thickness [e] such that 0.05 μm≤e≤50 μm,
a dielectric strength [E] such that E≥50 V/μm, and as

A/ the interface between the dielectric film 100a and the first structure 200 meets the following requirements:
the portion of the opposite surface S where said first structure 200 is directly in contact with said dielectric film 100a is greater than 90%,
in all the areas of the interface where the dielectric film 100a is not directly in contact with said first structure 200, they are locally separated by N (with N≥1) thicknesses of “parasitic” dielectrics 400a, . . . , 400c, each thickness having a relative dielectric permittivity [εₚ^{j}] and a dielectric strength [Eₚ^{j}] which satisfy the relation:

εₚ^{j}Eₚj≥εE

where “p” means “thickness of parasitic dielectrics” and “j” refers to the “j^{th}” thickness, with 1≤j≤N,

B/ the interface between the dielectric film 100 and the second structure 300 meets the following requirements:
the portion of the opposite surface S where said second structure 300 is directly in contact with the dielectric film 100 is greater than 90%,
in all the areas of the interface where the dielectric film 100 is not directly in contact with said second structure 300, they are separated locally by M (with M≥1) thicknesses of “parasitic” dielectrics 500a, . . . , 500c, each thickness having a relative dielectric permittivity [εₚ^{k}] and a dielectric strength [Eₚ^{k}] which satisfy the relation:

εₚ^{k}Eₚ^{k}≥εE

where “p” means “thickness of parasitic dielectrics” and “k” refers to the “k^{th}” thickness, with 1≤k≤M.

But in many cases, the dielectric film 100a is not unique and a dielectric layer consisting of a superposition of several films 100a, 100b, . . . , 100i is then involved.

FIGS. 5 and 6 represent, in a manner similar to FIGS. 1 and 2, a VHCFC 1 which still constitutes an ideal case in which the interface areas between the dielectric film 100a of the dielectric layer 100 and the ECBS 200, as well as the interface areas between the dielectric film 100b of the dielectric layer 100 and the ECBS 300 are devoid of any imperfection, so that their adhesion is perfect. The same applies for the interface between the two dielectric films 100a and 100b of the layer 100.

In the case above, only two films 100a and 100b are present. But what has just been specified is also valid when more than two films, including for all the interface areas between two films, are involved.

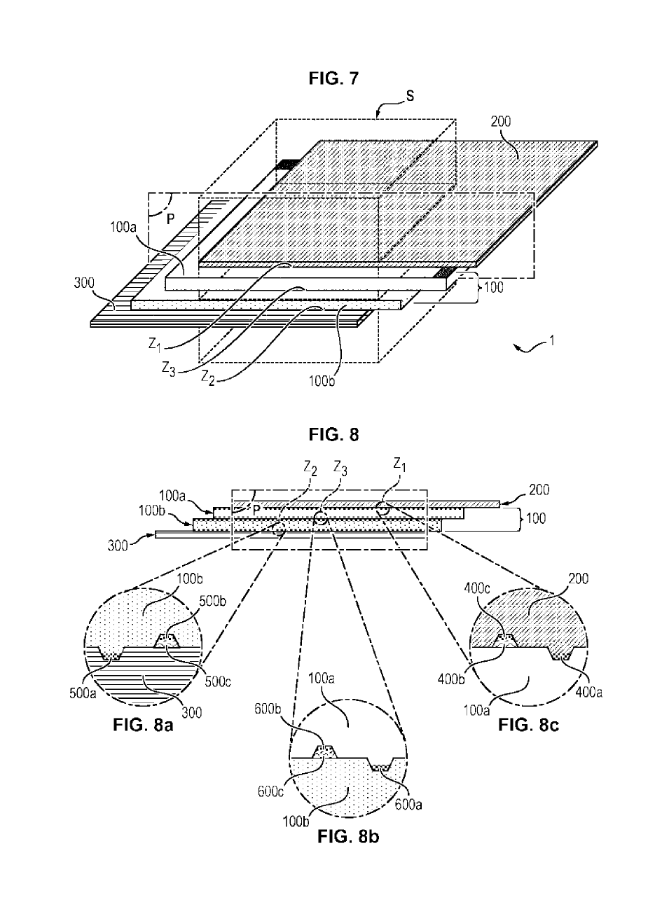

In practice and as illustrated in FIG. 7 comparable to the case illustrated in FIG. 3, the opposite sides of each layer of the film 100 and of the two ECBSs 200 and 300 on the one hand, and the opposite sides the layers of the film 100 on the other hand, are irregular, so that they are separated locally by at least one thickness of parasitic dielectrics.

Referring now to FIG. 8, three areas Z1, Z2 and Z3 where at least one thickness of parasitic dielectrics is involved, are represented by way of example.

Areas Z1 and Z2 are similar to areas Z1 and Z2 described above with reference to FIGS. 3 and 4.

As for the area Z3, it is located at the interface between the films 100a and 100b of the layer 100.

It shows a first thickness of parasitic dielectrics 600a interposed between a protrusion on the surface of the film 100a and a recess on the surface of the film 100b.

It also distinguishes, but in another location, two successive thicknesses 600b and 600c at the interface.

These are again very simplified artist views given by way of illustration. Neither the geometry (width, thickness, shape, etc.), nor the position at the interface, nor the constitution (one or two thicknesses of parasitic dielectrics) are representative of reality.

Also in this case, the present applicant has highlighted the fact that it is possible to obtain a quality VHCFC, this very high capacitance film capacitor 1 including a dielectric layer 100 consisting of at least one dielectric film 100a, each dielectric film 100i of this dielectric layer 100 having the following parameters:
a relative dielectric permittivity [ε_{f}ⁱ] such that ε_{f}ⁱ≥10,
a thickness [e_{f}ⁱ] such that 0.05 μm≤e_{f}ⁱ≤50 μm,
a dielectric strength [E_{f}ⁱ] such that E_{f}ⁱ≥50 V/μm,

parameters in which “f” means “film” and i≥1, “i” designating the “i^{th}” dielectric film 100i of said dielectric layer 100,

this dielectric layer 100 separating a first ECBS 200 from a second ECBS 300, these two structures having an opposite surface S separated by the dielectric layer 100,

since:

A/ the interface between the dielectric layer 100 and the first structure 200 meets the following requirements:
the portion of the opposite surface S where said first structure 200 is directly in contact with said dielectric layer 100 is greater than 90%,
in all the areas of the interface where the dielectric layer 100 is not directly in contact with said first structure 200, they are locally separated by N (with N≥1) thicknesses of “parasitic” dielectrics 400, each thickness having a relative dielectric permittivity [εₚ^{j}] and a dielectric strength [Eₚ^{j}] which satisfy the relation:

εₚ^{j}Eₚ^{j}≥Min(ε_{f}ⁱE_{f}ⁱ)

where “p” means “thickness of parasitic dielectrics” and “j” refers to the “j^{th}” thickness, with 1≤j≤N,

B/ the interface between the dielectric layer 100 and the second structure 300 meets the following requirements:
the portion of the opposite surface S where said second structure 300 is directly in contact with said dielectric layer 100 is greater than 90%,
in all the areas of the interface where the dielectric layer 100 is not directly in contact with said second structure 300, they are locally separated by M (with M≥1) thicknesses of “parasitic” dielectrics 500, each thickness having a relative dielectric permittivity [εₚ^{k}] and a dielectric strength [Eₚ^{k}] which satisfy the relation:

εₚ^{k}Eₚ^{k}≥Min(ε_{f}^{k}E_{f}^{k})

where “p” means “thickness of parasitic dielectrics” and “k” refers to the “k^{th}” thickness, with 1≤k≤M,

with the following additional condition:

C/ when said dielectric layer 100 consists of more than one dielectric film 100i, then any interface Σ between two dielectric films 100a satisfies the following conditions:
the portion of the opposite surface S where the two dielectric films 100a are directly in contact is greater than 90%,
in all the areas of the interface Σ where the two dielectric films 100a are not directly in contact, these films are separated locally by P_{Σ} (with P_{Σ}≥1) thicknesses of “parasitic” dielectrics 600, each thickness having a relative dielectric permittivity [εₚ^{l}] and a dielectric strength [Eₚ^{l}] which satisfy the relation:

εₚ^{l}Eₚ^{l}≥Min(ε_{f}ⁱE_{f}ⁱ)

where “p” means “thickness of parasitic dielectrics” and “l” refers to the “l^{th}” thickness, with 1≤l≤P_{Σ}.

In other words, the design of the stack which constitutes the capacitor is made so that, in the area corresponding to the opposite surface of the two charge-bearing structures, at best 100% of the surface of a dielectric film is in contact either with a charge-bearing structure or with another dielectric film, to avoid the presence of parasitic dielectric areas at the different interfaces.

The advantage of having a dielectric layer consisting of several dielectric films is to minimize the influence of a defect in a dielectric film. Indeed, it is statistically unlikely that N defects are superimposed in a stack of N dielectric films (N≥2). The presence of a defect in a dielectric film is therefore not unacceptable relative to the stack. In the presence of a single film, the defect is inherently unacceptable.

Hereinafter there will be described a method which makes it possible to obtain a capacitor as presented above.

### Example 1

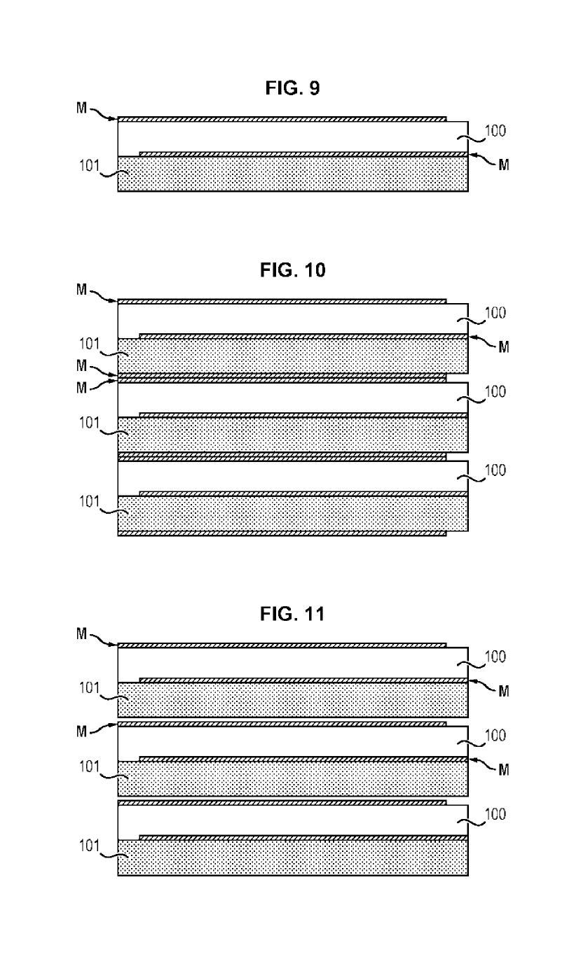

In the context of this example, the following assumptions are taken into account:
The main dielectric film 100, of dielectric permittivity ε_{f}≥10, is not self-supporting. It can be manufactured only by extrusion or coating for example, in a thickness from 0.05 μm to 50 μm, on a support layer 101.
The support layer 101 (FIG. 9) is a dielectric film which is metallized on at least one of its sides, of relative dielectric permittivity [ε_{f}′] and of thickness [e_{f}′].
The dielectric film 100 is deposited on a metallized side of the support layer 101 so that the dielectric film 100 is in direct contact with the metallized side of the support layer 101, in the sense defined above in the description.
The main dielectric film 100, with its support layer 101, is capable of undergoing a conventional metallization method, such as vacuum evaporation, for example.

Throughout this example and in FIGS. 9 to 17, the metallized sides are referred as M.

This method is implemented by a first metallization step of the free side of the main dielectric film 100 to obtain the basic configuration as defined above in the description. Thus, the dielectric film 100 is directly in contact with two opposite electronic charge-bearing structures.

FIG. 9 illustrates the result of the implementation of this step.

A second step consists of manufacturing the capacitor itself. For this, it is necessary to coil on itself the metallized dielectric film 100 provided with its support layer 101 or stack several identical structures of this type.

The dielectric character of the support layer 101 then acts as complementary insulator between the two ECBSs (in this case the coiled or stacked metallized sides). It is therefore necessary to satisfy the following relation:

e_{f}′E_{f}′≥e_{f}E_{f}

so that the capacitor can operate independently of any breakdown through the support layer 101.

To do this, a first variant consists of using a support layer 101 which is metallized on its two opposite sides, taking care to match the metallization of the free side with that of the main dielectric film 100 (this means that the metallizations are mirrored from one another). Thus, the two metallized sides match at the time of coiling or stacking, so that they then behave as one and the same ECBS.

Reference can be made to FIG. 10 which illustrates the result of this first variant implemented by operating a stack.

A second variant consists in using a support layer 101 which is metallized only on one side.

Under these conditions, the non-metallized side of the support layer 101 is a priori not in direct contact with the metallized side of the dielectric film 100, in the sense defined above in the description. “Parasitic” dielectric areas may therefore exist at the interface.

In this case, it is advantageous to use a support layer 101 of relative dielectric permittivity ε_{f}′≤10, while satisfying the conventional principles of manufacturing a metallized film capacitor (heat treatment for example).

FIG. 11 illustrates the result obtained by implementing this second variant, as part of a stack.

This is again a very simplified artist view given by way of illustration. Especially, the spacing represented is exaggerated and is not representative of reality.

Another variant would be to take the following precautions:

A first precaution is to carry out the operations of coiling or stacking under vacuum (pressure ≤10 mbar typically).

A second precaution, independent of the previous one, is to use, as a metallized layer or as a complement thereto, porous metal strips which, by letting the air escape at the time of coiling or stacking, will ensuring direct contact between ECBS and dielectric films.

A third precaution, complementary to the previous ones, is to ensure a good plating of each new layer on the previous ones during coiling or stacking, by the application of a pressure via a pressure roller for example, or by a relevant control of the tension angle in the implementation of the coiling.

### Example 2

In the context of this example, the following assumptions are taken into account:
The main dielectric film 100, of ε_{f}≥10, is not self-supporting. It can only be manufactured, by extrusion or coating for example, in a thickness from 0.05 μm to 50 μm, on a support layer 300.
The support layer 300 is a metal strip.
The dielectric film 100 is deposited on at least one side of the support layer 300, so that the dielectric film 100 is in direct contact with the support film 300, in the sense defined above in the description.
The main dielectric film 100, with its support layer 300, is a priori not capable of undergoing a conventional metallization method.

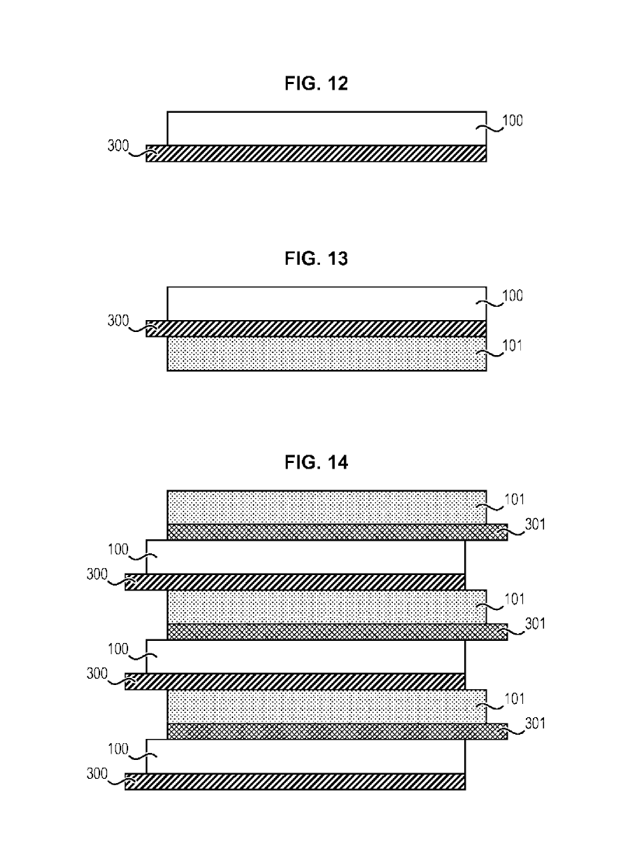

FIG. 12 represents such a dielectric film based on a metal strip 300, while FIG. 13 represents the structure of FIG. 12, itself based on another dielectric film 101.

It appears quite clearly that this last configuration is very close to the previous configuration, except that the films 100 and 300 are to be considered as a single entity, and must follow the same recommendations as those expressed above. It will be advantageous to use as films 101 and 301 (FIG. 14), an assembly of the same nature as the films 100 and 300, which makes it possible to double the volume capacitance of the capacitor. This is done in fact if the dielectric film 100 is deposited on both sides of the support layer 300, which then identifies with the film 101.

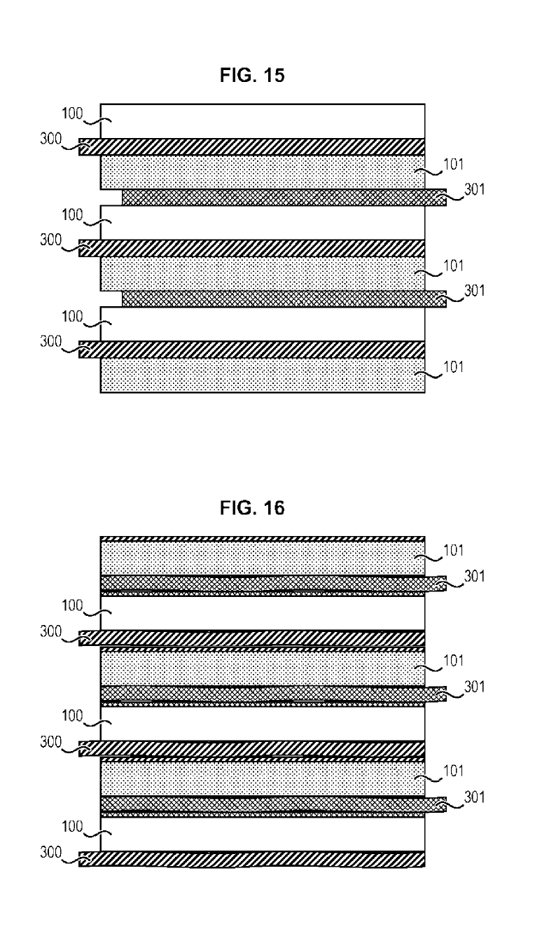

FIG. 14 represents a stack of several structures such as the one represented in FIG. 12, while FIG. 15 represents a stack of several structures such as the one represented in FIG. 13.

FIG. 15 represents, without any other deposition in the stack, the ECBS 301 which constitutes the second pole of the VHCFC, the dielectric films 100 and 101, charged with the electrical insulation between both ECBSs, being already borne by the other ECBS 300.

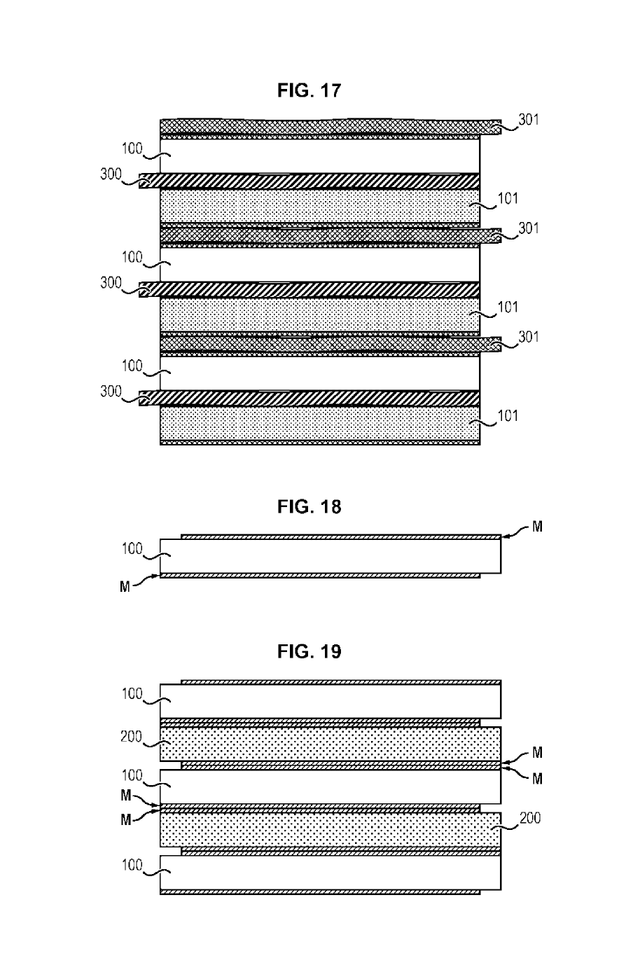

Again, an important variant lies in the fact that the main dielectric film 100, with its support film 300, is capable of undergoing a conventional metallization method, such as vacuum evaporation, for example. This variant follows the same recommendations as those above (recommendations described at the end of Example 1—another variant), whether in the case of a metallization of a side (as shown by the stack of FIG. 16) or in the case of metallization of the two sides (as shown by the stack of FIG. 17). In these FIGS. 16 and 17 as for FIG. 24, the layers are represented with corrugations to represent the absence of uniformity and regularity of their surface. But again, this is just an illusion.

In the examples which have been described above, the case is selected wherein the main dielectric film was not self-supporting.

However, it is also possible to manufacture a film capacitor in accordance with the invention, with a main dielectric film which is self-supporting.

This aspect will be described in detail below, with reference to FIG. 18 and following figures.

### Example 3

In the context of this example, the following assumptions are taken into account:
The main dielectric film 100, of ε_{f}≥10, is self-supporting. It can be manufactured, by extrusion or coating for example, in a thickness from 0.05 μm to 50 μm.
The self-supporting film is capable of undergoing a conventional metallization method, such as vacuum evaporation for example.

The method is implemented by a first step of metallizing the two sides of a self-supporting film 100 to obtain the basic configuration as defined above in the description. Thus, the dielectric film is directly in contact with two opposite electronic charge-bearing structures.

FIG. 18 illustrates the result of the implementation of this step.

In this figure and following figures, the metallization layers are referenced as M.

A second step consists of manufacturing the capacitor itself. To do so, it is required to coil the metallized dielectric film on its both sides 100 or stack several identical structures of this type. It is however required to insulate the two metallized sides from each other during coiling or stacking, by the introduction of a second dielectric film 200.

To do this, a first variant consists of using a dielectric film 200 which is metallized on its both sides, taking care to match the metallized sides (so that the films are mirrored from each other). Thus, the two sides matching at the time of coiling or stacking then act as one and the same ECBS.

In this case, we will take advantage of the fact that using films 100 and 200 of the same nature makes it possible to double the volume capacitance of the capacitor.

On the other hand, if a dielectric film 200 of different nature (of thickness [e_{f}′] and of dielectric strength [E_{f}′]) is used, it will be then necessary to satisfy the following rule:

e_{f}′E_{f}′≥e_{f}E_{f}

so that the capacitor can operate independently of any breakdown through the second dielectric film 200.

Reference can be made to FIG. 19 which illustrates the result of this first variant implemented as part of a stack.

A second variant consists of using a dielectric film 100 which is metallized on only one side, taking care to match the metallized side with one of those of the dielectric film 100. Thus, the metallization of the dielectric film 200 is mirrored with one of the metallizations of the dielectric film 100, and the two sides matching at the time of coiling or stacking then act as one and the same ECBS.

However, the non-metallized side of the dielectric film 200 is a priori not in direct contact with the second metallized side of the dielectric film 100, in the sense defined above in the description. “Parasitic” dielectric areas may therefore exist at the interface.

In this case, it is advantageous to use a dielectric film 200 of relative dielectric permittivity ε_{f}′≤10 while satisfying the conventional principles of manufacturing a metallized film capacitor (heat treatment for example).

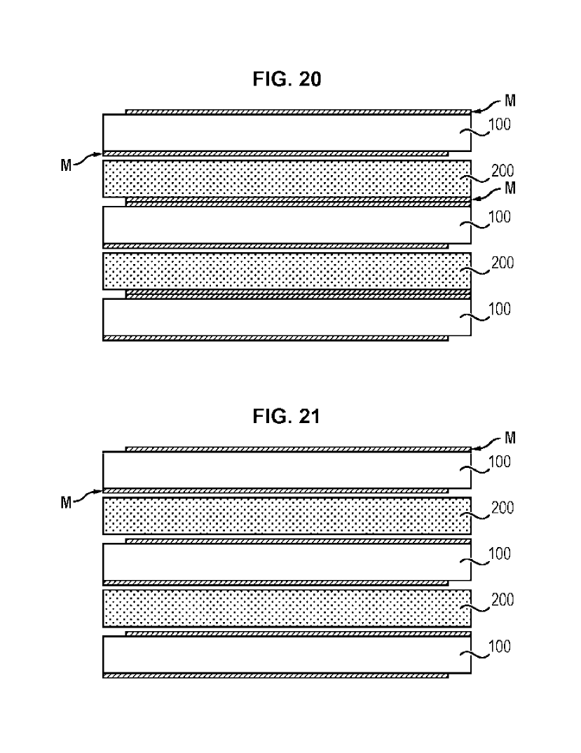

Reference can be made to FIG. 20 which illustrates the result of this second variant of implementation as part of a stack.

This is again a very simplified artist view given by way of illustration. Especially, the spacing represented is exaggerated and is not representative of reality.

Another variant would be to use the principles presented above, at the end of Example 1.

A third variant consists of using a non-metallized dielectric film 200.

In this case, none of the sides of the dielectric film 200 is a priori in direct contact with the metallized sides of the dielectric film 100, in the sense defined above in the description. “Parasitic” dielectric areas may therefore exist at each interface.

In this case, it is advantageous to use a dielectric film 200 of relative dielectric permittivity ε_{f}′≤10 while satisfying the conventional principles of manufacturing a metallized film capacitor (heat treatment for example). The result of the implementation of this variant is illustrated in FIG. 21, with the same reserves of representativeness as those seen in FIG. 20.

Another variant would be to use the principles presented above, at the end of Example 1.

### Example 4

In the context of this example, the following assumptions are taken into account:

The main dielectric film 100, of ε_{f}≥10, is self-supporting. Films of this material, of thickness [e_{f}] from 0.05 μm to 50 μm, can be manufactured by extrusion or coating, for example.

The main dielectric film 100 is a priori not capable of undergoing a conventional metallization method.

The method is then carried out by coiling (for the coiled capacitor version) or by stacking (for the stacked capacitor version):
of a first metal strip 300 which constitutes the first ECBS,
of a first main dielectric film 100,
of a second metal strip 400 which constitutes the second ECBS,
of a second dielectric film 200 (of thickness [e_{f}′], and of dielectric strength [E_{f}′]) to isolate both ECBSs.

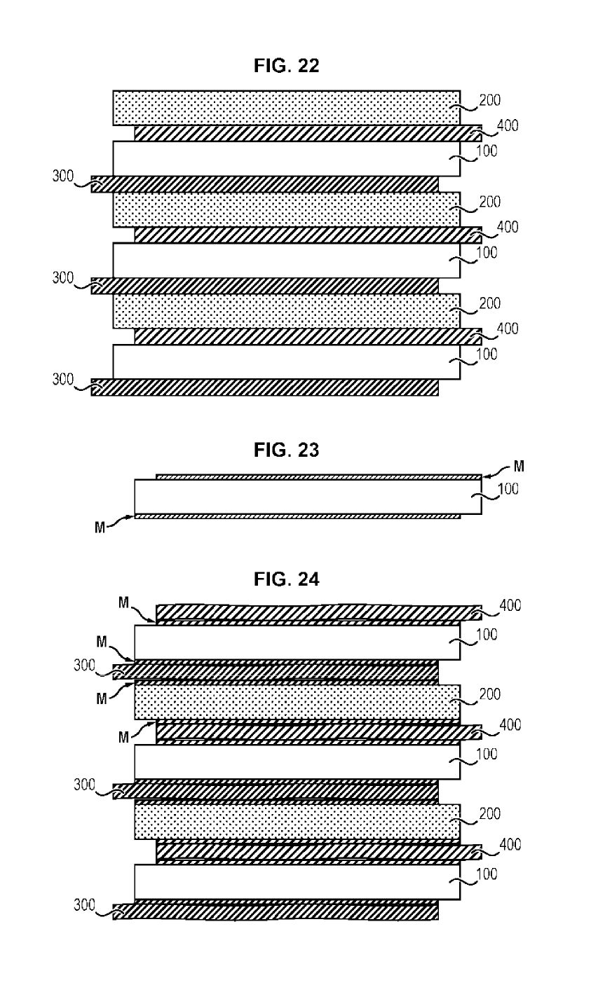

In the case of a stack, a structure such as the one represented in FIG. 22 is then obtained.

It is advantageous to use films 100 and 200 of the same nature, which makes it possible to double the volume capacitance of the capacitor. If a dielectric film 200 of different nature (of thickness [e_{f}′], and of dielectric strength [E_{f}′]) is used, it will be necessary to satisfy the following rule:

e_{f}′E_{f}′≥e_{f}E_{f}

such that the capacitor can operate independently of any breakdown through the dielectric film 200.

Another possibility is to use the principles presented above, at the end of Example 1.

A variant can be considered when the main dielectric film 100 is capable of undergoing a conventional metallization method, such as vacuum evaporation for example.

Indeed, during the use of a capacitor configuration, any film can be made necessary if the power requested by the application is too important to be transported by a simple metallization.

In this case, the method according to the invention is made by metallization of the two sides of the main dielectric film 100 to obtain the basic configuration as defined above in the description. Thus, a dielectric film is directly in contact with two opposite ECBSs.

The method resulting from this step is represented in FIG. 23.

A second step consists of manufacturing the capacitor itself. To that end, it suffices to apply the method described above.

In the case of a stack, a structure such as the one represented in FIG. 24 is then obtained. However, insofar as each metallized side will be in electrical contact with a metal strip, the final ECBS consist of the metal deposition and metal strip in contact. The main dielectric film therefore remains in direct contact with the two ECBSs.

As a remark, the metallization of both sides of the dielectric film 200 is recommended but not necessary, depending on its nature. Likewise, it is possible to consider a mixed method where only one side of the main dielectric film 100 would be metallized. In this case, it is necessary to follow the precautions required by the most constraining of the methods considered.

General Remarks:

The known techniques inherent in securing the metallized film capacitors (high-resistivity metallization, variable resistivity metallization, metallization with incorporated fuses, etc.) are advantageously applicable to all the metallized film configurations described above, however without the need to be detailed specifically.

However, these techniques can make it possible to reduce the threshold by 90% of direct contact or to authorize the presence, in areas without direct contact, of dielectrics not satisfying the conditions defined above. In doing so, there will be breakdowns localized on all the areas in question. But, subject to proper sizing of the safety devices, these breakdowns should themselves be secure. The consequence is an electrical isolation de facto of the areas in question and the achievement of an ideal configuration with 100% of direct contact between dielectric film and ECBS. This is done to the detriment of the opposite connected surface, which will have decreased the total surface of the secured areas.

The known technique inherent in securing the metallized film capacitors which uses fuses incorporated in the metallization works on the principle of an adequacy between the energy locally stored in the capacitor (that is to say in a reasonably close environment in terms of electricity of the fuse) and the energy required to operate (i.e., demetallize) said fuse and, optionally, the surrounding area. Such a technique is not applicable in a conventional all-film capacitor, that is to say using a dielectric insulator of low relative permittivity ε_{f} (ε_{f}<10).

Indeed, the locally available energy remains too low compared to the energy that would be needed to melt a fuse designed in the metal sheet that serves as ECBS. This is no longer the case in a VHCFC where the high relative permittivity of the electrical insulator (ε_{f}≥10) makes it possible to significantly increase the energy density stored.

All-film capacitors can be conceived, made according to the configurations described above and using one or more ECBSs 300 and/or 400 including directly incorporated fuses, as they would be for a metallization. The techniques of manufacturing fuses will obviously be different. The following techniques can be considered:

1/ removal of material from a solid metal sheet, the remaining material constituting the fuses:
by vaporization of the metal by laser or the same,
by punching or mechanical drilling of the metal,
by dissolution or chemical etching of the metal,

2/ addition of material to a solid metal sheet, part of the added material constituting the fuses:
by welding or brazing, possibly by bridges which may act as fuses, or any other physical association technique,
by clinching, stamping or any other mechanical association technique,

this list is not exhaustive.

The known techniques inherent manufacturing a capacitor (respect of a margin, of a possible film offset, use of a corrugated edge, metallization by projection, heat treatment, connectivity, packaging, under-voltage burn-in, disconnection system in case of overpressure, etc.) are advantageously applicable to all the configurations described here.

It is clear that most of what is presented in the present application can be applied to a dielectric layer consisting of several dielectric films and not of a single dielectric film, on condition that a direct contact, in the sense defined above, is respected at each interface in the dielectric layer.

1. A very high capacitance film capacitor which includes a dielectric layer consisting of at least one dielectric film, each dielectric film of this dielectric layer having the following parameters:
a relative dielectric permittivity [ε_{f}ⁱ] such that ε_{f}ⁱ≥10,
a thickness [e_{f}ⁱ] such that 0.05 μm≤e_{f}ⁱ≤50 μm,
a dielectric strength [E_{f}ⁱ] such that E_{f}ⁱ≥50 V/μm,
parameters in which “f” means “film” and i≥1, “i” designating the “i^{th}” dielectric film of said dielectric layer,
this dielectric layer separating a first electronic charge-bearing structure from a second electronic charge-bearing structure, these two structures having an opposite surface separated by the dielectric layer,
A/ the interface between the dielectric layer and the first structure meets the following requirements:
the portion of the opposite surface where said first structure is directly in contact with said dielectric layer is greater than 90%,
in all the areas of the interface where the dielectric layer is not directly in contact with said first structure, they are separated locally by N (with N≥1) thicknesses of “parasitic” dielectrics”, each thickness having a relative dielectric permittivity [εₚ^{j}] and a dielectric strength [Eₚ^{j}] which satisfy the relation:
εₚ^{j}Eₚ^{j}≥Min(ε_{f}ⁱE_{f}ⁱ)
where “p” means “thickness of parasitic dielectrics” and “j” refers to the “j^{th}” thickness, with 1≤j≤N,
B/ the interface between the dielectric layer and the second structure meets the following requirements:
the portion of the opposite surface (S) where said second structure is directly in contact with said dielectric layer is greater than 90%,
in all the areas of the interface where the dielectric layer is not directly in contact with said second structure, they are locally separated by M (with M≥1) thicknesses of “parasitic” dielectrics”, each thickness having a relative dielectric permittivity [εₚ^{k}] and a dielectric strength [Eₚ^{k}] which satisfy the relation:
εₚ^{k}Eₚ^{k}≥Min(ε_{f}ⁱE_{f}ⁱ)
where “p” means “thickness of parasitic dielectrics” and “k” refers to the “k^{th}” thickness, with 1≤k≤M,
with the following additional condition:
C/ when said dielectric layer consists of more than one dielectric film, then any interface Σ between two dielectric films satisfies the following conditions:
the portion of the opposite surface (S) where the two dielectric films are directly in contact is greater than 90%,
in all the areas of the interface Σ where the two dielectric films are not directly in contact, these films are locally separated by P_{Σ} (with P_{Σ}≥1) thicknesses of “parasitic” dielectrics, each thickness having a relative dielectric permittivity [εₚ^{l}] and a dielectric strength [Eₚ^{l}] which satisfy the relation:
εₚ^{l}Eₚ^{l}≥Min(ε_{f}ⁱE_{f}ⁱ)
where “p” means “thickness of parasitic dielectrics” and “l” refers to the “l^{th}” thickness, with 1≤l≤P_{Σ}, said dielectric layer being made of polymer material or based on polymer material, excluding an exclusively mineral material.

2. The film capacitor according to claim 1, wherein said dielectric layer is not self-supporting.

3. A method for manufacturing a film capacitor according to claim 2, wherein it has the following successive steps:
a) using a second dielectric layer called “support layer”, of relative dielectric permittivity [ϵ_{f}′] and of thickness [e_{f}′], which is metallized on at least one of its two opposite sides, and of dielectric strength [E_{f}′];
b) depositing said dielectric layer on said support layer so that it is in contact with a metallized side of this support layer;
c) proceeding to the metallization of the side of said dielectric layer which remained free at the end of step b);
d) proceeding to the coiling on itself of the set resulting from step c) or to the stacking of several sets resulting from step c);
said dielectric layer and support layer satisfying the following relation:
e_{f}′ E_{f}′≥e_{f} E_{f}, wherein the expressions e_{f} and Eᵣ are respectively the thickness and the dielectric strength of said dielectric layer.

4. The method according to claim 3, wherein it uses a support film which is metallized on its both sides, and that in step d), the metallized surface of said dielectric layer is matched, that is to say mirrored, with that of one of the sides of said support layer.

5. The method according to claim 3, wherein a metallized support film on one of its sides is used and that in step d), the metallized surface of said dielectric layer is matched, that is to say mirrored, with that of said support layer.

6. The method according to claim 5, wherein a support layer whose relative electric permittivity [ε_{f}′] is less than or equal to 10, is used.

7. The method according to claim 3, wherein the implementation of step d) is carried out by operating under vacuum or at a pressure less than or equal to 10 mbar.

8. The method according to claim 3, wherein in step d), a plating of a new set on the previous one is carried out by applying a pressure, especially via a pressure roller, or by controlling the tension angle.

9. The method according to claim 3, wherein it has the following steps:
a) depositing said dielectric layer on a support film consisting of a metal strip;
b) depositing the set resulting from step a) on a dielectric support layer;
c) depositing the set resulting from step b) on a second support film consisting of a metal strip;
d) proceeding to the coiling on itself of the set resulting from step c) or to the stacking of several sets resulting from step c).

10. The method according to claim 9, wherein said dielectric layers are identical.

11. The method according to claim 9, wherein said support films are identical metal strips.

12. The method according to claim 9, wherein, between said steps a) and b), the side of said dielectric layer that has remained free is subjected to a metallization.

13. The method according to claim 12, wherein, between said steps b) and c), the side of said dielectric support layer that has remained free is subjected to a metallization.

14. The method according to claim 9, wherein the implementation of step d) is carried out by operating under vacuum or at a pressure less than or equal to 10 mbar, is carried out.

15. The method according to claim 9, wherein in step d), a plating of a new set on the previous one is carried out by applying a pressure, especially via a pressure roller, or by controlling the tension angle.

16. The method according to claim 9, wherein porous strips are used.

17. The method according to claim 9, wherein strips which incorporate fuses are used.

18. The method of claim 17, wherein the incorporation of said fuses is carried out by using either of the following techniques:
removal of material from said strip, so that the remaining material constitutes said fuses, which removal is carried out by a technique such as spraying of the metal, punching or mechanical drilling of the metal, dissolution or chemical etching of the metal;
addition of material to said strip, so that the added material constitutes said fuses, which addition is carried out by a technique such as welding, brazing, clinching or stamping.
